(19) United States
(12) Patent Application Publication
(10) Pub. No.: US 2024/0202879 A1
(43) Pub. Date: Jun. 20, 2024

(54) IMAGE PROCESSING METHOD AND IMAGE PROCESSING SYSTEM

(71) Applicant: SAMSUNG ELECTRONICS CO., LTD., SUWON-SI (KR)

(72) Inventors: Jinwoo LEE, SUWON-SI (KR); Bumjoo LEE, SUWON-SI (KR); Su-Young LEE, SUWON-SI (KR)

(21) Appl. No.: 18/471,504

(22) Filed: Sep. 21, 2023

(30) Foreign Application Priority Data
Dec. 15, 2022 (KR) 10-2022-0176186

(51) Int. Cl. G06T 5/50; G06T 5/00; G06T 7/11; G06T 7/62

(52) U.S. Cl. CPC G06T 5/50; G06T 5/002; G06T 7/11; G06T 7/62; G06T 2207/20132; G06T 2207/20216

(57) ABSTRACT

An image processing method includes generating a full image of an area of interest in which unit patterns are repeatedly arranged, blurring each of the unit patterns, calculating respective center positions of each of the unit patterns based on the blurring, setting respective reference positions on each of the unit patterns based on the center positions, cropping the full image into a plurality of unit images, and merging the plurality of unit images based on the reference positions to generate an averaged image.

### CROSS-REFERENCE TO RELATED APPLICATION

This application claims priority under 35 U.S.C. § 119 from Korean Patent Application No. 10-2022-0176186, filed on Dec. 15, 2022 in the Korean Intellectual Property Office, the disclosure of which is herein incorporated by reference in its entirety.

### FIELD

The present disclosure generally relates to image processing, and more particularly relates to an image processing method and an image processing system.

### DISCUSSION

As development of semiconductor devices increases, the importance of evaluating a semiconductor device manufacturing process is similarly increasing. For example, the semiconductor device manufacturing process may be evaluated based on an image obtained through a scanning electron microscope (SEM).

In order to increase accuracy of the evaluation on the semiconductor device manufacturing process, it may be desirable to reduce noise encountered when capturing an image of a semiconductor device and to improve a signal-to-noise ratio (SNR) of the image.

### SUMMARY

Embodiments of the present disclosure may provide an image processing method with an improved signal-to-noise ratio.

Embodiments of the present disclosure may provide an image processing system with an improved signal-to-noise ratio.

According to an embodiment of the present inventive concept, an image processing method includes: generating a full image of an area of interest in which unit patterns are repeatedly arranged; blurring each of the unit patterns; calculating respective center positions of each of the unit patterns based on the blurring; setting respective reference positions on each of the unit patterns based on the center positions; cropping the full image into a plurality of unit images; and merging the plurality of unit images based on the reference positions to generate an averaged image.

According to an embodiment of the present inventive concept, an image processing system includes: a memory storing a program therein; and a processor, wherein, when the program is executed by the processor, the program is configured to: generate a full image of an area of interest in which unit patterns are repeatedly arranged; blur each of the unit patterns; calculate respective center positions of each of the unit patterns based on the blurring; set respective reference positions on each of the unit patterns based on the center positions; crop the full image into a plurality of unit images; and merge the plurality of unit images based on the reference positions to generate an averaged image.

According to an embodiment of the present inventive concept, an image processing method includes: generating a full image of an area of interest in which unit patterns are repeatedly arranged; calculating a period at which the unit patterns are repeatedly arranged; cropping the full image into a plurality of unit images based on the period; blurring each of the plurality of unit images; calculating respective center positions of each of the unit patterns on a respective one of the plurality of unit images based on the blurring; setting respective reference positions on each of the plurality of unit images based on a respective one of the center positions; and merging the plurality of unit images based on the reference positions to generate an averaged image.

Embodiments of the present disclosure are not limited to those mentioned above or described below. Other embodiments according to the present disclosure may be more clearly understood based on the illustrative embodiments provided by way of example according to the present disclosure. Further, it will be easily understood that alternate embodiments according to the present disclosure may be realized using means shown in the description and/or claims, and combinations thereof.

### BRIEF DESCRIPTION OF DRAWINGS

The above and other embodiments of the present disclosure will become more apparent by describing in detail some embodiments thereof with reference to the attached drawings, in which:

FIG. 1 is a block diagram illustrating an image processing system according to an illustrative embodiment.

FIG. 2 is a block diagram illustrating an image processing module of FIG. 1.

FIG. 3 is a block diagram illustrating a pattern measuring module of FIG. 1.

FIG. 4 is a flowchart diagram illustrating an image processing method according to an illustrative embodiment.

FIG. 5 through FIG. 10 are image diagrams illustrating an image processing method according to an illustrative embodiment.

FIG. 11 and FIG. 12 are graphical diagrams illustrating profile change according to an image processing method.

FIG. 13 through FIG. 15 are image diagrams illustrating an image processing method according to an embodiment an illustrative embodiment.

FIG. 16 through FIG. 21 are hybrid conceptual diagrams illustrating an edge profile distribution of the averaged image.

FIG. 22 and FIG. 23 are image diagrams illustrating whether a pattern is defective using an averaged image.

FIG. 24 is a flowchart diagram illustrating an image processing method according to an illustrative embodiment.

FIG. 25 through FIG. 27 are image diagrams for illustrating an image processing method according to an illustrative embodiment.

### DETAILED DESCRIPTION

Hereinafter, embodiments illustrating the technical basis of the present disclosure will be described by way of example with reference to the accompanying drawings.

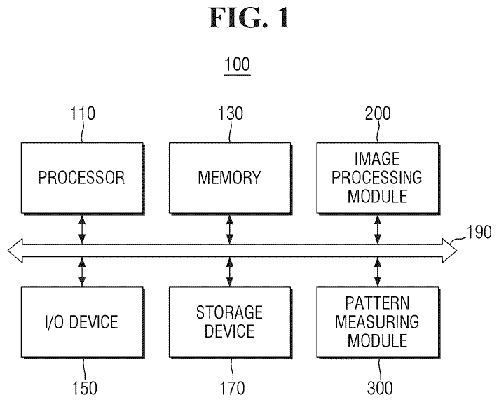

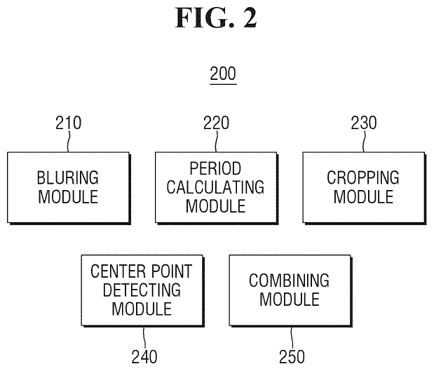

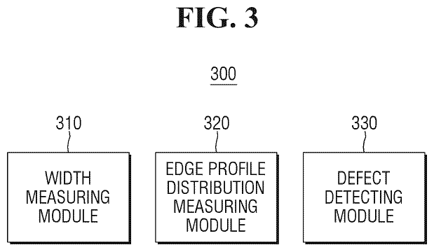

FIG. 1 illustrates an image processing system according to some embodiments. FIG. 2 illustrates an image processing module of FIG. 1. FIG. 3 illustrates a pattern measuring module of FIG. 1.

Referring to FIG. 1 through FIG. 3, an image processing system 100 according to an embodiment may include a processor 110, a memory 130, an input/output device 150, a storage device 170, a bus 190, an image processing module 200, and a pattern measuring module 300.

The image processing system 100 may be implemented as an integrated device, without limitation thereto. For example, the image processing system 100 may be provided as a dedicated device for processing an image. In another example, the image processing system 100 may be implemented with a computer for operating various modules for processing an image.

The processor 110 may control the image processing system 100. The processor 110 may execute an operating system, firmware, or the like for operating the image processing system 100.

The processor 110 may include a core capable of executing any instructions, such as, for example, a microprocessor, an Application Processor (AP), a Digital Signal Processor (DSP), and/or a Graphics Processing Unit (GPU).

The processor 110 may communicate with the memory 130, the input/output device 150, and the storage device 170 via the bus 190. The processor 110 may process an image using the image processing module 200. For example, the processor 110 may reduce noise in the image using the image processing module 200 loaded in the memory 130. The processor 110 may measure a pattern using the pattern measuring module 300. For example, the processor 110 may measure a width of the pattern, an edge profile of the pattern, or the like using the pattern measuring module 300 loaded in the memory 130.

The processor 110 may operate a profile calculating module 210 loaded into the memory 130 to calculate a profile of the pattern using a captured pattern image. The processor 110 may integrate multiple profiles using an integrating module 220 loaded into the memory 130.

The image processing module 200 may be a program or a software module including instructions executed by the processor 110. The image processing module 200 may be stored in a computer-readable storage medium, without limitation thereto.

The image processing module 200 may include a blurring module 210, a period calculating module 220, a cropping module 230, a center point detecting module 240, and a combining module 250. The blurring module 210 may be a program including instructions for performing a blurring process on an image. The period calculating module 220 may be a program including instructions for calculating a period of a pattern using an image. The cropping module 230 may be a program including instructions for cropping a full image into unit images. The center point detecting module 240 may be a program including instructions for detecting a center position of a unit pattern. The combining module 250 may be a program including instructions for combining unit images with each other to generate an averaged image.

The memory 130 may temporarily store therein program instructions and/or data for the image processing module 200 or the pattern measuring module 300. In one example, the image processing module 200 or the pattern measuring module 300 may be loaded from the storage device 170 into the memory 130.

The memory 130 may be embodied as a volatile memory, such as SRAM or DRAM, or a non-volatile memory, such as PRAM, MRAM, ReRAM, FRAM, or a flash memory such as NOR flash or NAND flash, without limitation thereto.

The input/output device 150 may control a user input from and an output to user interface devices. For example, the input/output device 150 may include an input device such as a keyboard, a mouse, a touchpad, or the like, and thus may receive various data. For example, the input/output device 150 may include an output device such as a display and/or a speaker to output various types of data.

The storage device 170 may store therein various data related to the image processing module 200 or the pattern measuring module 300. Moreover, the storage device 170 may store therein codes such as the operating system or the firmware executed by the processor 110.

The storage device 170 may include, for example, a memory card (MMC, eMMC, SD, MicroSD, or the like), an SSD (solid state drive), an HDD (hard disk drive), or the like.

The pattern measuring module 300 may be a program or a software module including instructions executed by the processor 110. The pattern measuring module 300 may be stored in a computer-readable storage medium, without limitation thereto.

The pattern measuring module 300 may include a width measuring module 310, an edge profile distribution measuring module 320, a defect detecting module 330, or the like. The width measuring module 310 may be a program including instructions for measuring a width of a pattern using an averaged image. The edge profile distribution measuring module 320 may be a program including instructions for measuring a distribution of an edge profile of a pattern using an averaged image. The defect detecting module 330 may be a program including instructions for detecting whether the pattern is defective using an averaged image.

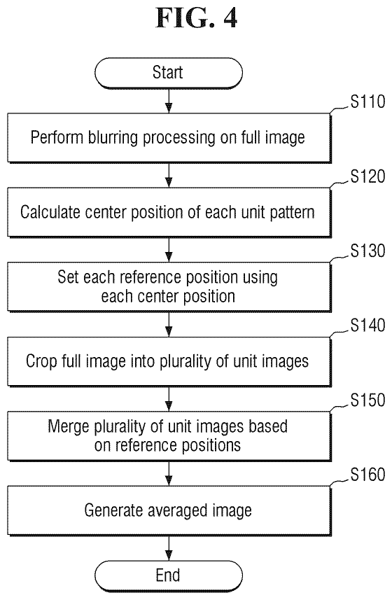

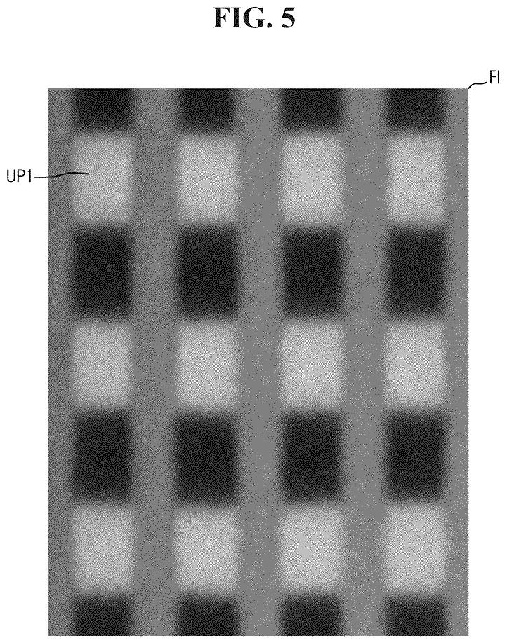

FIG. 4 illustrates an image processing method according to an embodiment. FIG. 5 through FIG. 10 illustrate an image processing method according to an embodiment.

Referring to FIG. 1, FIG. 2, and FIG. 4 through FIG. 6, the image processing system 100 according to an embodiment may perform a blurring process on a full image FI in S110.

The image processing module 200 of the image processing system 100 may perform a blurring process operation on the full image FI. The processor 110 may operate the blurring module 210 of the image processing module 200 to perform a blurring process on the full image FI.

For example, the full image FI may include a first unit pattern UP. The full image FI may include repeatedly arranged first unit patterns UP. A size of the full image FI may be changed according to a user setting. Accordingly, the number of the first unit patterns UP included in the full image FI may also be changed according to such settings or embodiments.

The full image FI may be subjected to the blurring process and thus be changed into a blur image BI. For example, the full image FI may be subjected to the blurring process using a smoothing filter. For example, the full image FI may be blurred using Gaussian blurring processing.

The blur image BI may be an image corrected to include a signal having a signal value that is equal to or greater than a threshold value among image signals of the full image FI. For example, the blur image BI may include a signal having a gray-level data value equal to or greater than a threshold value among image signals of the full image FI, and may be free of a signal having a gray-level data value lower than the threshold value among the image signals of the full image FI.

The blur image BI may include a second unit pattern UP2. The second unit pattern UP2 may correspond to a portion of the first unit pattern UP. The second unit pattern UP2 may have a form in which a portion of the first unit pattern UP has been removed via the blurring process.

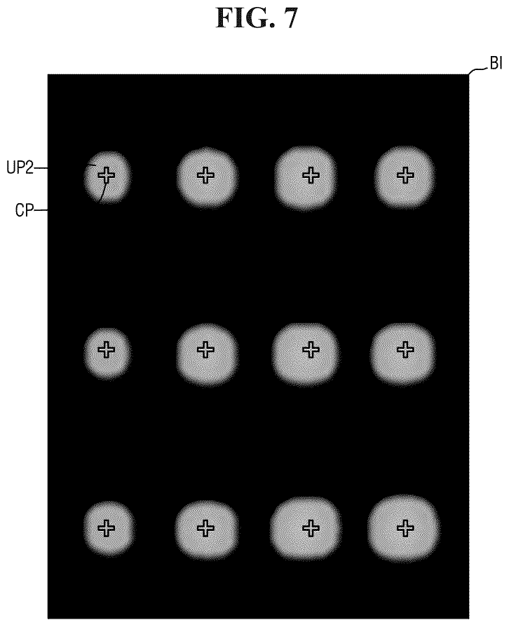

Referring back to FIG. 1, FIG. 2, FIG. 4, and FIG. 7, the image processing system 100 according to an embodiment may calculate a center position CP of a unit pattern in S120.

The image processing module 200 of the image processing system 100 may calculate the center position CP of the unit pattern. The center point detecting module 240 of the image processing module 200 may calculate the center position CP of the unit pattern. For example, the center point detecting module 240 may calculate a center position CP of the second unit pattern UP2 of the blur image BI. In this regard, the center position CP of the second unit pattern UP2 may be the same as a center position of the first unit pattern (UP1 in FIG. 5).

The center point detecting module 240 may calculate the center position CP using an image signal of the second unit pattern UP2 on the blur image BI. For example, when the image signal of the second unit pattern UP2 is gray-level data, a point where the gray-level data has a maximum value may be calculated as the center position CP.

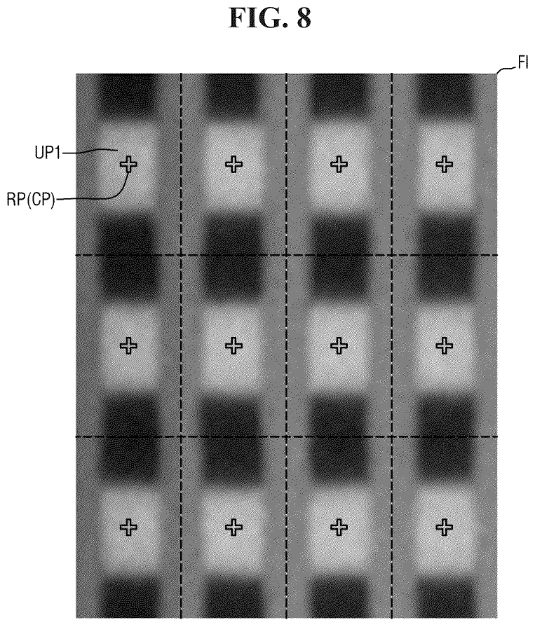

Referring to FIG. 1, FIG. 2, FIG. 4, and FIG. 8, the image processing system 100 according to an embodiment may set a reference position RP in S130.

The image processing system 100 may set the reference position RP on the full image FI. The reference position RP may substantially coincide with the center position CPCP. In this regard, the reference position RP coinciding with the center position CP may indicate that coordinates of the reference position RP and the center position CP on the image are the same as each other. Each of the coordinate of the reference position RP and the coordinate of the center position CP may include a pixel coordinate.

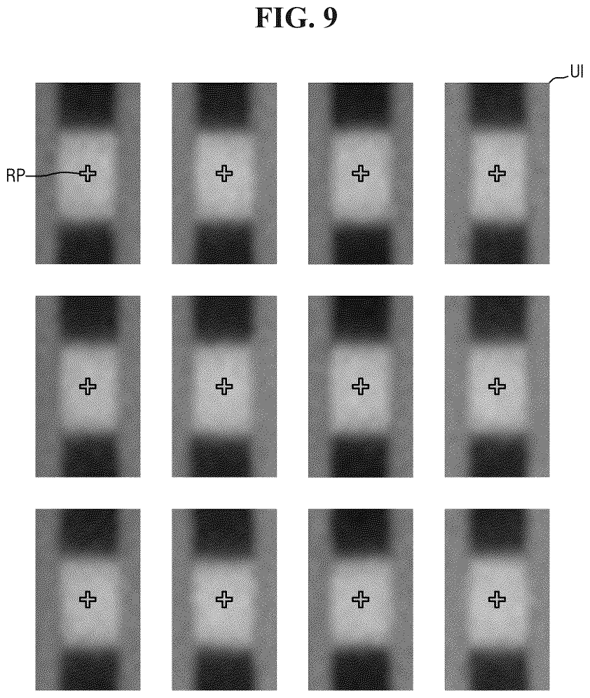

Referring to FIG. 1, FIG. 2, FIG. 4, and FIG. 9, the image processing system 100 according to an embodiment may generate unit images UI in S140.

The cropping module 230 of the image processing module 200 may crop the full image (FI in FIG. 8) into the unit images UI. Each of the unit images UI may have a preset size. For example, the user may arbitrarily set the size of each of the unit images UI. The size of each of the unit images UI may be changed according to a user setting.

Each of the unit images UI may include a reference position RP. All of the reference positions RP of the unit images UI need not be identical with each other. For example, when the unit images UI having the same size overlap each other, the reference positions RP thereof need not overlap each other.

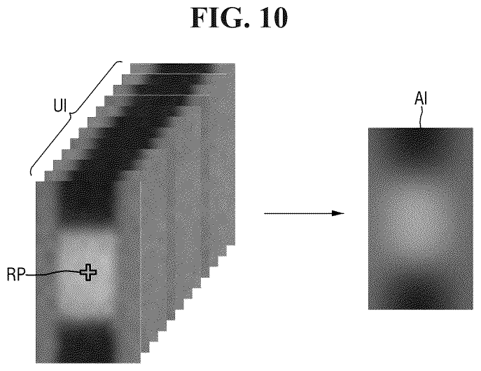

Referring to FIG. 1, FIG. 2, FIG. 4, and FIG. 10, the image processing system 100 according to an embodiment may merge the unit images UI in S150. Next, the image processing system 100 according to an embodiment may merge the unit images UI to generate an averaged image AI in S160.

For example, the combining module 250 of the image processing module 200 may merge the unit images UI. The combining module 250 may merge the unit images UI based on the reference positions RP. The combining module 250 may overlap the unit images UI with each other so that the coordinates of the reference positions RP of the unit images UI coincide with each other. The combining module 250 may combine the unit images UI to generate the averaged image AI.

The image processing module 200 of the image processing system 100 may calculate a center position CP of each pattern without using edge information of each pattern. That is, the image processing module 200 may perform the blurring process on the image where the patterns are arranged, and may analyze an image signal of each of the patterns on the blurred image to calculate the center position CP thereof. Calculating the center position using the pattern edge information may have lowered accuracy when there is a lot of noise in the image.

Further, the image processing system 100 may crop one full image FI in which the patterns UP1 are repeatedly arranged into the unit images UI and then may merge the unit images UI to generate the averaged image AI. Accordingly, the image processing system 100 need not repeatedly measure and image a semiconductor device on which the patterns are arranged.

For example, when another image processing system repeatedly measures and images the semiconductor device on which the patterns are arranged using a scanning electron microscope (SEM), charges may accumulate on a surface of the semiconductor device such that the captured image may be distorted. Therefore, the image processing system 100 does not repeatedly measure the semiconductor device but crops the full image FI thereof into the unit images UI and merges the unit images UI to generate the averaged image AI, thereby preventing deterioration of the accuracy due to image distortion.

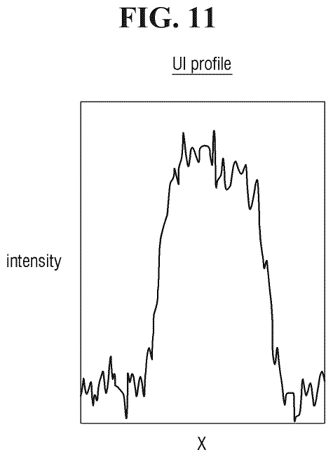

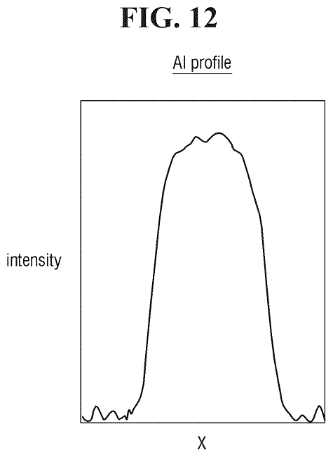

FIG. 11 and FIG. 12 illustrate profile change according to image processing. For reference, FIG. 11 shows a profile of the unit image (UI in FIG. 10), and FIG. 12 shows a profile of the averaged image (AI in FIG. 10).

Referring to FIG. 10 through FIG. 12, a profile of an image signal of the unit image UI may have a noise amount larger than that of a profile of an image signal of the averaged image AI. The averaged image AI obtained by overlapping the unit images UI with each other may have an improved signal-to-noise ratio (SNR).

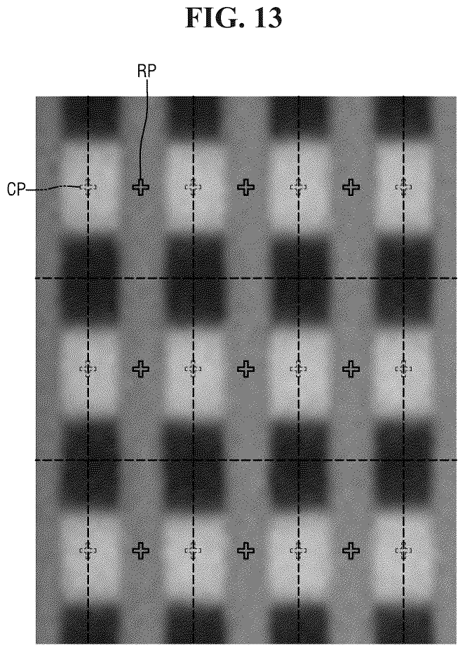

FIG. 13 through FIG. 15 illustrate an image processing method according to an embodiment. For reference, FIG. 13 shows a step after FIG. 7.

Referring to FIG. 4, FIG. 7, and FIG. 13, the image processing system 100 according to an embodiment may correct the center position CP to set the reference position RP in S130.

The reference position RP may be a position obtained by correcting the center position CP by a preset offset. In this regard, the reference position RP and the center position CP need not coincide with each other. A user may set the offset by which the center position CP is corrected to the reference position RP, based on a pattern of interest.

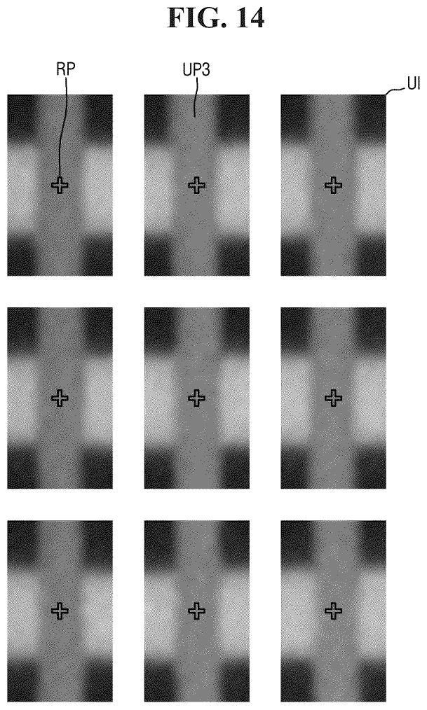

Referring to FIG. 4 and FIG. 14, the image processing system 100 according to an embodiment may crop the full image into unit images UI, each including a reference position RP in S140.

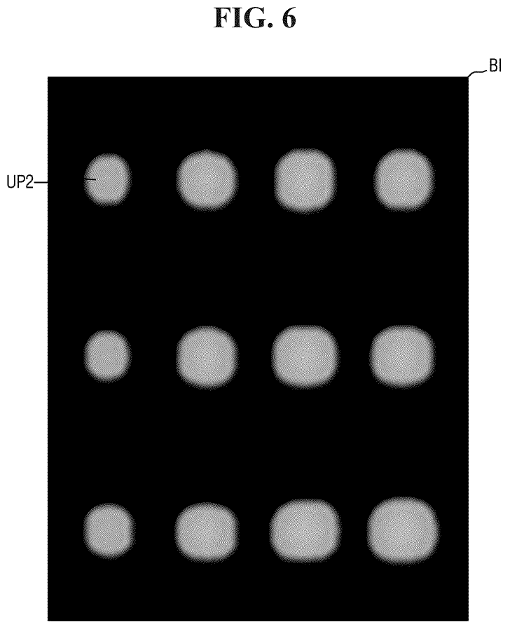

The unit image UI may include a third unit pattern UP3. For example, when the center position CP and the reference position RP do not coincide with each other, the unit image UI may include a unit pattern different from the unit pattern based on which the center position CP has been calculated. The third unit pattern UP3 need not be identical with each of the first unit pattern (UP1 in FIG. 5) of the full image (FI in FIG. 5) based on which the center position CP is calculated, and the second unit pattern (UP2 in FIG. 6) of the blur image (BI of FIG. 6).

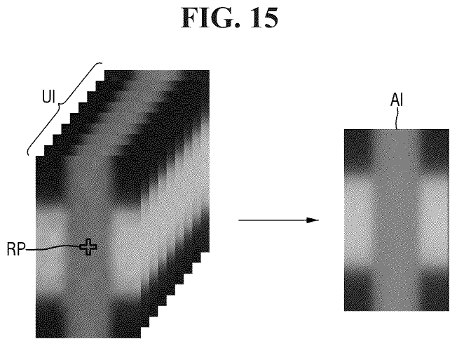

For example, referring to FIG. 4 and FIG. 15, the image processing system 100 may merge the unit images UI based on the reference position RP to generate the averaged image AI in S150 and S160.

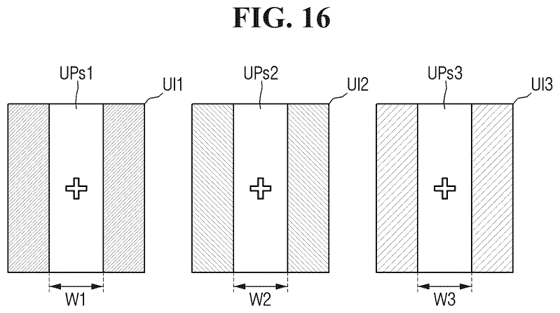

FIG. 16 through FIG. 21 illustrate an edge profile distribution of the averaged image. For reference, each of FIG. 16 through FIG. 21 illustrates an edge distribution of a pattern.

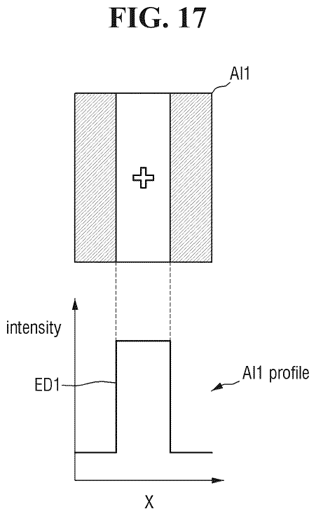

Referring to FIG. 16 and FIG. 17, a first unit image UI1 may include a first sub-unit pattern UPs1. The first sub-unit pattern UPs1 may have a first width W1. A second unit image UI2 may include a second sub-unit pattern UPs2. The second sub-unit pattern UPs2 may have a second width W2. A third unit image UI3 may include a third sub-unit pattern UPs3. The third sub-unit pattern UPs3 may have a third width W3. In this regard, the first width W1, the second width W2 and the third width W3 may be equal to each other. That is, edges of the first sub-unit pattern UPs1, the second sub-unit pattern UPs2, and the third sub-unit pattern UPs3 may coincide with each other.

A first averaged image AI1 is an averaged image obtained by combining the first unit image UI1, the second unit image UI2, and the third unit image UI3 with each other. A profile of the first averaged image AI1 may represent an intensity of an image signal according to a coordinate x on the image.

The profile of the first averaged image AI1 may have a first edge distribution ED1. In this regard, the first edge distribution ED1 on the profile of the first averaged image AI1 may have an infinite slope. This may be due to the fact that the edges of the first sub-unit pattern UPs1, the second sub-unit pattern UPs2, and the third sub-unit pattern UPs3 coincide with each other.

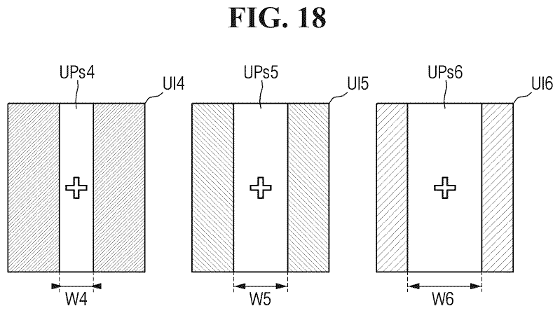

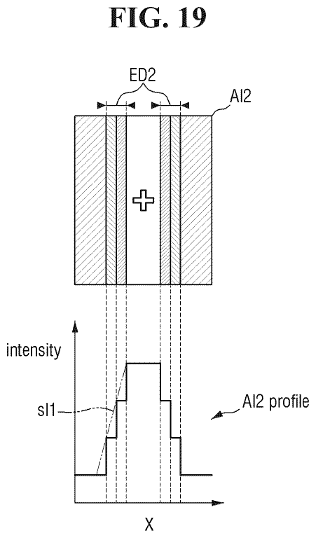

Referring to FIG. 18 and FIG. 19, a fourth unit image UI4 may include a fourth sub-unit pattern UPs4. The fourth sub-unit pattern UPs4 may have a fourth width W4. A fifth unit image UI5 may include a fifth sub-unit pattern UPs5. The fifth sub-unit pattern UPs5 may have a fifth width W5. A sixth unit image UI6 may include a sixth sub-unit pattern UPs6. The sixth sub-unit pattern UPs6 may have a sixth width W6.

In this regard, the fourth width W4, the fifth width W5 and the sixth width W6 need not be equal to each other. For example, the fourth width W4 may be smaller than each of the fifth width W5 and the sixth width W6. The fifth width W5 may be larger than the fourth width W4 and may be smaller than the sixth width W6. The sixth width W6 may be greater than each of the fourth width W4 and the fifth width W5. That is, edges of the fourth sub-unit pattern UPs4, the fifth sub-unit pattern UPs5, and the sixth sub-unit pattern UPs6 need not coincide with each other.

A second averaged image AI2 is an averaged image obtained by combining the fourth unit image UI4, the fifth unit image UI5, and the sixth unit image UI6 with each other. A profile of the second averaged image AI2 may have a second edge distribution ED2. In this regard, the second edge distribution ED2 on the profile of the second averaged image AI2 may have a first slope sl1. This may be due to the fact that the edges of the fourth sub-unit pattern UPs4, the fifth sub-unit pattern UPs5, and the sixth sub-unit pattern UPs6 do not coincide with each other.

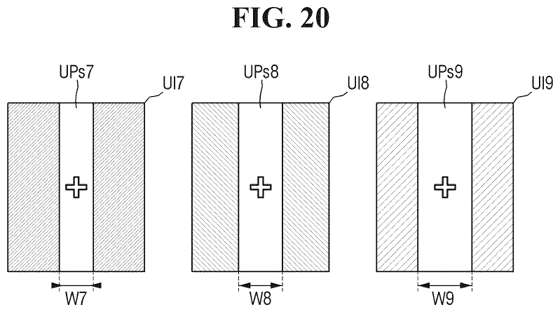

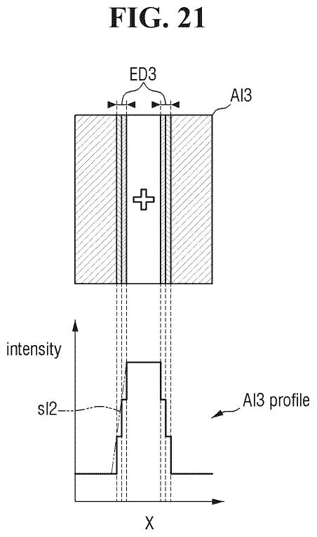

Referring to FIG. 20 and FIG. 21, a seventh unit image UI7 may include a seventh sub-unit pattern UPs7. The seventh sub-unit pattern UPs7 may have a seventh width W7. An eighth unit image UI8 may include an eighth sub-unit pattern UPs8. The eighth sub-unit pattern UPs8 may have an eighth width W8. A ninth unit image UI9 may include a ninth sub-unit pattern UPs9. The ninth sub-unit pattern UPs9 may have a ninth width W9.

In this regard, the seventh width W4, the eighth width W8 and the ninth width W9 need not be equal to each other. That is, the edges of the seventh sub-unit pattern UPs7, the eighth sub-unit pattern UPs8, and the ninth sub-unit pattern UPs9 need not coincide with each other.

A third averaged image AI3 is an averaged image obtained by combining the seventh unit image UI7, the eighth unit image UI8, and the ninth unit image UI9 with each other. A profile of the third averaged image AI3 may have a third edge distribution ED3. In this regard, the third edge distribution ED3 on the profile of the third averaged image AI3 may have a second slope sl2. This may be due to the fact that the edges of the seventh sub-unit pattern UPs7, the eighth sub-unit pattern UPs8, and the ninth sub-unit pattern UPs9 do not coincide with each other.

Further, referring to FIG. 19 and FIG. 21, the second slope sl2 of the third edge distribution ED3 on the profile of the third averaged image AI3 may be greater than the first slope sl1 of the second edge distribution ED2 on the profile of the second averaged image AI2. This may be due to a fact that the distribution of the edges of the fourth sub-unit pattern UPs4, the fifth sub-unit pattern UPs5, and the sixth sub-unit pattern UPs6 is larger than the distribution of the edges of the seventh sub-unit pattern UPs7, the eighth sub-unit pattern UPs8, and the ninth sub-unit pattern UPs9.

Referring to FIG. 1, FIG. 3, and FIG. 16 through FIG. 21, the width measuring module 310 of the pattern measuring module 300 may measure a width of the pattern. For example, the width measuring module 310 may measure the first to ninth widths W1 to W9 of the first sub-unit pattern to the ninth sub-unit pattern UPs1 to UPs9. The width measuring module 310 may respectively calculate the widths of the first sub-unit pattern to the ninth sub-unit pattern UPs1 to UPs9 using the profiles of the image signals thereof.

Further, the edge profile distribution measuring module 320 of the pattern measuring module 300 may measure the distribution of the edges of the patterns using the averaged image. For example, the edge profile distribution measuring module 320 may measure the first edge distribution to the third edge distribution ED1 to ED3 using the first averaged image to the third averaged image AI1 to AI3, respectively.

The image processing system 100 may check whether the patterns are uniformly formed based on the distribution of the edges of the patterns using the averaged image.

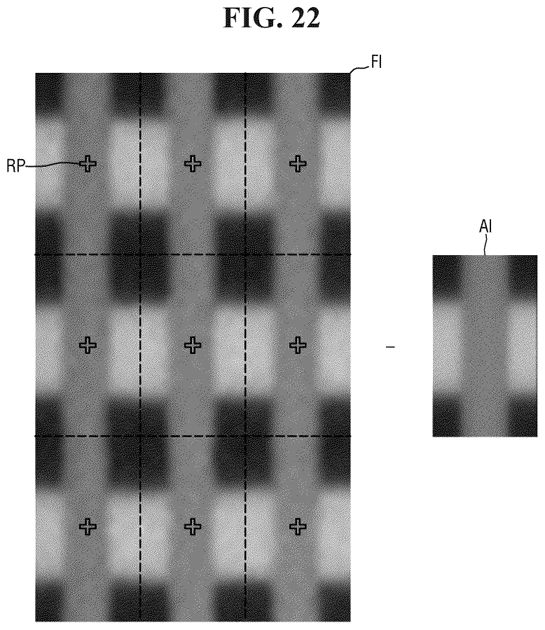

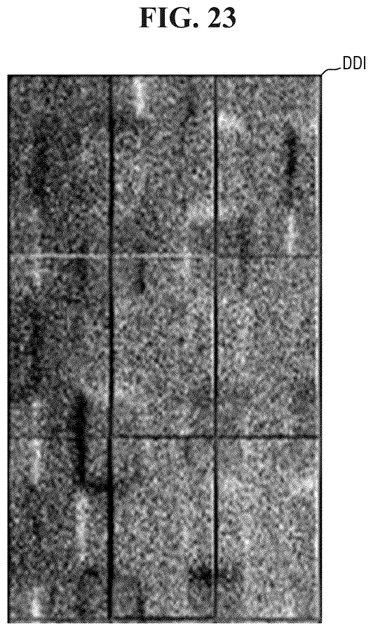

FIG. 22 and FIG. 23 illustrate whether a pattern is defective using an averaged image.

Referring to FIG. 1, FIG. 3, and FIG. 22, the image processing system 100 may detect whether the pattern is defective using the full image FI and the averaged image AI.

For example, the defect detecting module 330 of the pattern measuring module 300 may detect whether the pattern is defective using the full image FI and the averaged image AI. The processor 110 may operate the defect detecting module 330 to detect whether the pattern is defective.

The defect detecting module 330 may be a program including instructions for performing an operation of subtracting the averaged image AI from the full image FI. The processor 110 may operate the defect detecting module 330 to perform an operation of subtracting the averaged image AI from each of the unit images UI on the full image FI.

Referring to FIG. 23, a defect detecting image DDI may be an image obtained by subtracting the averaged image AI from each of the unit images UI on the full image FI. When the unit pattern in the unit image UI is defective, an abnormal image may appear on the defect detecting image DDI.

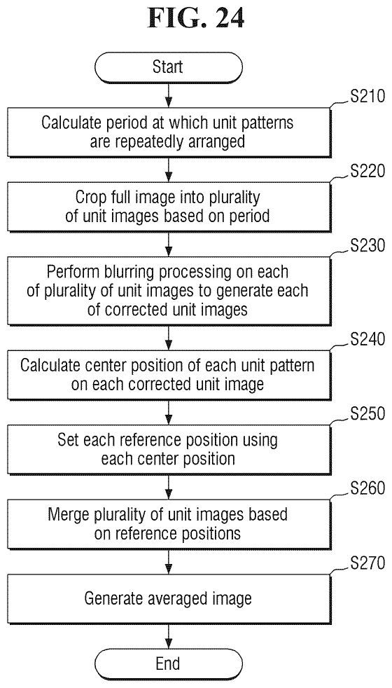

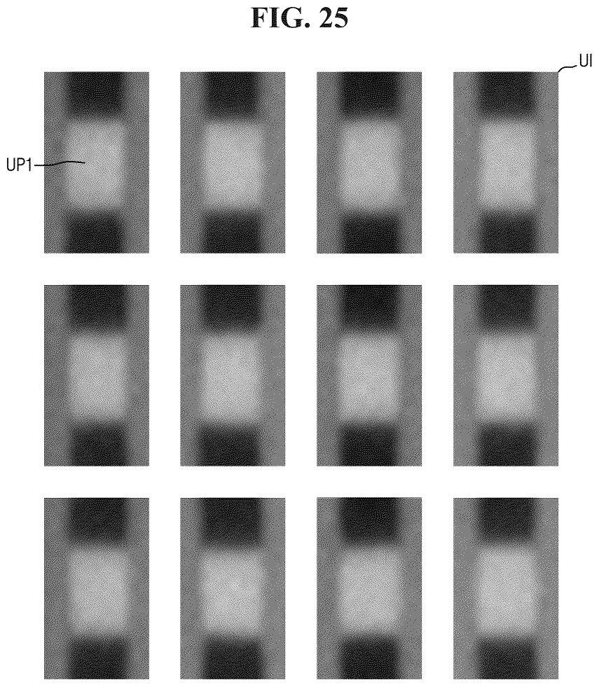

FIG. 24 illustrates an image processing method according to an embodiment. FIG. 25 through FIG. 27 illustrate an image processing method according to an embodiment. For reference, FIG. 25 shows a step after FIG. 5. For convenience of description, the following descriptions are based on differences thereof from the descriptions as set forth above with respect to FIG. 4 through FIG. 10. Substantially duplicate description may be omitted.

Referring to FIG. 1, FIG. 2, FIG. 5, and FIG. 24, the image processing system 100 according to an embodiment may calculate a period of the first unit pattern UP1 in the full image FI in S210.

The period calculating module 220 of the image processing module 200 may calculate the period of the first unit pattern UP1 in the full image FI. For example, the period calculating module 220 may be a program including instructions for performing fast Fourier transform on the full image FI.

The processor 110 may operate the period calculating module 220 to perform the fast Fourier transform on the image signal of the full image FI. Thus, the period calculating module 220 may calculate the period of the first unit pattern UP1 at which the first unit patterns UP1 are repeated.

Referring to FIG. 1, FIG. 2, FIG. 5, FIG. 24, and FIG. 25, the image processing system 100 according to an embodiment may crop the full image FI to the unit images UI based on the period of the first unit pattern UP1 in S220.

For example, the cropping module 230 of the image processing module 200 may crop the full image FI into the unit images UI based on the period of the first unit pattern UP1 as calculated by the period calculating module 220. Each of the unit images UI may include the first unit pattern UP1.

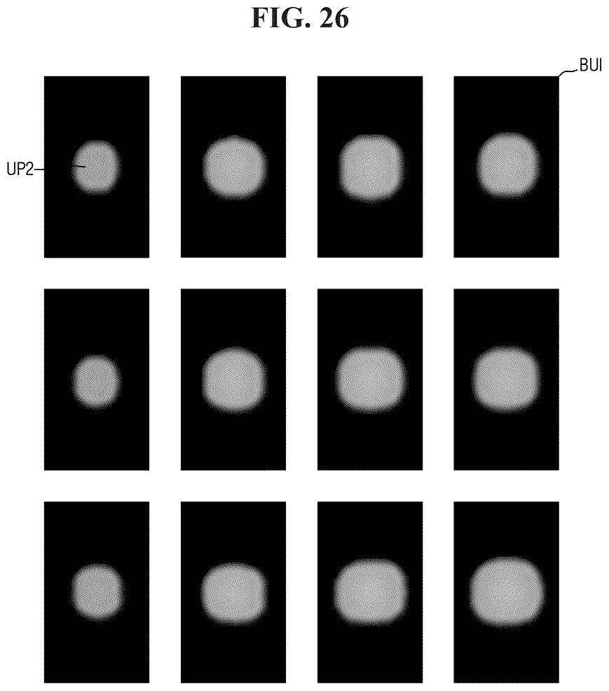

Referring to FIG. 1, FIG. 2, FIG. 24, and FIG. 26, the image processing system 100 according to an embodiment may generate corrected unit images BUI in S230.

The image processing module 200 of the image processing system 100 may perform a blurring process on each of the unit images UI. For example, the processor 110 may operate the blurring module 210 to perform the blurring process on each of the unit images UI. The processor 110 may execute the blurring module 210 to perform the blurring process on each of the unit images UI to generate the corrected unit images BUI. Each of the corrected unit images BUI may include the second unit pattern UP2.

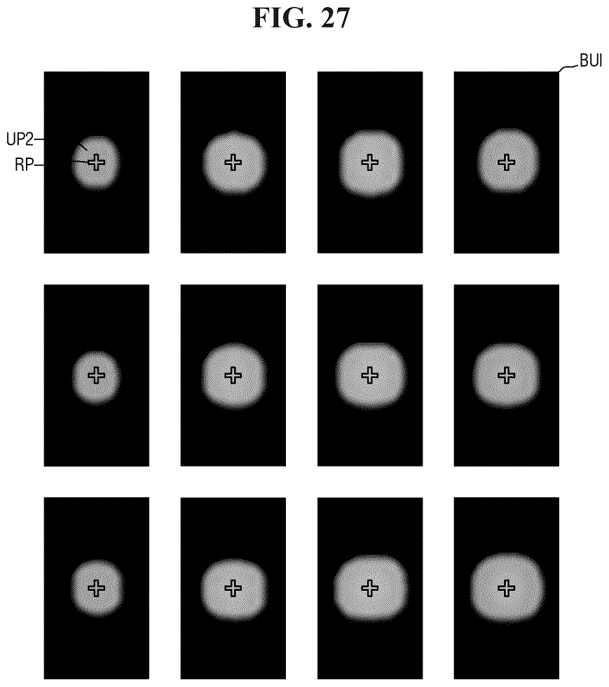

Referring to FIG. 1, FIG. 2, FIG. 24, and FIG. 27, the image processing system 100 according to an embodiment may calculate a center position CP in each of the corrected unit images BUI in S240.

The center point detecting module 240 of the image processing module 200 may calculate the center position CP of the second unit pattern UP2 in each of the corrected unit images BUI.

For example, referring to FIG. 24 and FIG. 9, the image processing system 100 according to an embodiment may set a reference position RP in S250.

The image processing system 100 may set the reference position RP on each of the unit images (UI in FIG. 25) obtained in S220. For example, the reference position RP may coincide with the center position CP. In another example, the reference position RP need not coincide with the center position CP. The reference position RP may be a position corrected by a predetermined offset from the center position CP.

Referring back to FIG. 24 and FIG. 10, the image processing system 100 according to an embodiment may merge the unit images UI in S260. For example, the image processing system 100 according to an embodiment may generate the averaged image AI obtained by merging the unit images UI in S270.

In concluding the detailed description, those of ordinary skill in the pertinent art will appreciate that many variations and modifications may be made to the described embodiments without substantially departing from the principles of the present disclosure. Therefore, the disclosed embodiments are used in a generic and descriptive sense by way of example, and not for purposes of limitation.

What is claimed is:

1. An image processing method comprising:
generating a full image of an area of interest in which unit patterns are repeatedly arranged;
blurring each of the unit patterns;
calculating respective center positions of each of the unit patterns based on the blurring;
setting respective reference positions on each of the unit patterns based on the center positions;
cropping the full image into a plurality of unit images; and
merging the plurality of unit images based on the reference positions to generate an averaged image.

2. The image processing method of claim 1, further comprising calculating a period at which the unit patterns are repeatedly arranged, based on the full image.

3. The image processing method of claim 2, wherein calculating the period includes performing a fast Fourier transform (FFT) on an image signal of the full image.

4. The image processing method of claim 2, wherein cropping the full image into the plurality of unit images is based on the period.

5. The image processing method of claim 1, wherein cropping the full image into the plurality of unit images is based on a preset size.

6. The image processing method of claim 1, wherein each of the center positions is substantially coincident with a respective one of the reference positions.

7. The image processing method of claim 1, wherein setting each of the reference positions includes correcting a respective center position by a preset offset.

8. The image processing method of claim 1,
wherein cropping the full image into the plurality of unit images is performed before blurring each of the unit patterns,
wherein blurring each of the unit patterns includes blurring a respective one of the plurality of unit images, respectively,
wherein calculating the respective center positions of each of the unit patterns is based on a respective one of the plurality of blurred unit images,
wherein each of the plurality of unit images includes a respective one of the unit patterns.

9. The image processing method of claim 1,
wherein blurring the unit patterns includes blurring the full image,
wherein calculating the respective center positions of each of the unit patterns is based on the full image processed to be blurred.

10. The image processing method of claim 1, wherein blurring each of the unit patterns includes performing a Gaussian blurring process thereon.

11. The image processing method of claim 1, wherein generating the full image includes imaging the area of interest using a scanning electron microscope (SEM).

12. The image processing method of claim 1, wherein calculating the respective center positions of each of the unit patterns includes calculating a position where gray-level data of each unit pattern has a substantially maximum value.

13. An image processing system comprising:
a memory storing a program therein; and
a processor,
wherein, when the program is executed by the processor, the program is configured to:
generate a full image of an area of interest in which unit patterns are repeatedly arranged;
blur each of the unit patterns;
calculate respective center positions of each of the unit patterns based on the blurring;
set respective reference positions on each of the unit patterns based on the center positions;
crop the full image into a plurality of unit images; and
merge the plurality of unit images based on the reference positions to generate an averaged image.

14. The image processing system of claim 13, wherein when the program is executed by the processor, the program is further configured to:
subtract data of the averaged image from data of the full image; and
determine whether the unit pattern is defective, based on the subtraction result.

15. The image processing system of claim 13, wherein when the program is executed by the processor, the program is further configured to calculate a distribution of edge profiles of the unit patterns based on the averaged image.

16. The image processing system of claim 13, wherein when the program is executed by the processor, the program is further configured to measure a width of the unit pattern based on the averaged image.

17. The image processing system of claim 13, wherein when the program is executed by the processor, the program is further configured to calculate a profile of an image signal of the unit pattern based on the averaged image.

18. The image processing system of claim 13,
wherein cropping the full image into the plurality of unit images is performed before blurring each of the unit patterns,
wherein blurring each of the unit patterns includes blurring each of the plurality of unit images,
wherein calculating the center positions of each of the unit patterns is based on a respective one of the plurality of unit images subjected to blurring.

19. The image processing system of claim 13,
wherein blurring the unit patterns includes blurring the full image,
wherein calculating the center positions of each of the unit patterns is based on the full image processed to be blurred.

20. An image processing method comprising:
generating a full image of an area of interest in which unit patterns are repeatedly arranged;
calculating a period at which the unit patterns are repeatedly arranged;
cropping the full image into a plurality of unit images based on the period;
blurring each of the plurality of unit images;
calculating respective center positions of each of the unit patterns on a respective one of the plurality of unit images based on the blurring;
setting respective reference positions on each of the plurality of unit images based on a respective one of the center positions; and
merging the plurality of unit images based on the reference positions to generate an averaged image.
